(19) United States
(12) Patent Application Publication
(10) Pub. No.: US 2006/0101090 A1
(43) Pub. Date: May 11, 2006

(54) Method and system for reliable datagram tunnels for clusters

(76) Inventors: Eliezer Aloni, Zur Yigal (IL); Amit Oren, Palo Alto, CA (US); Caitlin Bestler, Laguna Hills, CA (US)

Correspondence Address: MCANDREWS HELD & MALLOY, LTD, 500 WEST MADISON STREET, SUITE 3400, CHICAGO, IL, 60661, US

(21) Appl. No.: 11/269,005

(22) Filed: Nov. 8, 2005

Related U.S. Application Data
(60) Provisional application No. 60/626,283, filed on Nov. 8, 2004.

(51) Int. Cl. G06F 17/30

(52) U.S. Cl. 707/201

(57) ABSTRACT

Aspects of a system for transporting information via a communications system may include a processor that establishes, via a local NIC, a communication channel between the local NIC and a remote NIC via a network. The processor may receive a datagram message from one of a plurality of local endpoints, communicatively coupled to the local NIC, without a dedicated connection. A datagram message may be delivered to one of a plurality of remote endpoints communicatively coupled to a remote NIC. The processor may communicate a datagram message via the local NIC to one of a plurality of remote endpoints via a communication channel without establishing a dedicated connection between one of the plurality of local endpoints and one of the plurality of remote endpoints.

### CROSS-REFERENCE TO RELATED APPLICATIONS/INCORPORATION BY REFERENCE

This application makes reference to, claims priority to, and claims the benefit of U.S. Provisional Application Ser. No. 60/626,283 filed Nov. 8, 2004.

This application also makes reference to:

U.S. application Ser. No. ______ (Attorney Docket No. 17097US02) filed on even date herewith; and

U.S. application Ser. No. ______ (Attorney Docket No. 17098US02) filed on even date herewith

Each of the above stated applications is hereby incorporated herein by reference in its entirety.

### FIELD OF THE INVENTION

Certain embodiments of the invention relate to data communications. More specifically, certain embodiments of the invention relate to a method and system for reliable datagram tunnels for clusters.

### BACKGROUND OF THE INVENTION

In conventional computing, a single computer system is often utilized to perform operations on data. The operations may be performed by a single processor, or central processing unit (CPU) within the computer. The operations performed on the data may include numerical calculations, or database access, for example. The CPU may perform the operations under the control of a stored program containing executable code. The code may include a series of instructions that may be executed by the CPU that cause the computer to perform specified operations on the data. The performance of a computer in performing operations may variously be measured in units of millions of instructions per second (MIPS), or millions of operations per second (MOPS).

Historically, increases in computer performance have depended on improvements in integrated circuit technology, often referred to as “Moore's law”. Moore's law postulates that the speed of integrated circuit devices may increase at a predictable, and approximately constant, rate over time. However, technology limitations may begin to limit the ability to maintain predictable speed improvements in integrated circuit devices.

Another approach to increasing computer performance implements changes in computer architecture. For example, the introduction of parallel processing may be utilized. In a parallel processing approach, computer systems may utilize a plurality of CPUs within a computer system that may work together to perform operations on data. Parallel processing computers may offer computing performance that may increase as the number of parallel processing CPUs in increased. The size and expense of parallel processing computer systems result in special purpose computer systems. This may limit the range of applications in which the systems may be feasibly or economically utilized.

An alternative to large parallel processing computer systems is cluster computing. In cluster computing a plurality of smaller computer, connected via a network, may work together to perform operations on data. Cluster computing systems may be implemented, for example, utilizing relatively low cost, general purpose, personal computers or servers. In a cluster computing environment, computers in the cluster may exchange information across a network similar to the way that parallel processing CPUs exchange information across an internal bus. Cluster computing systems may also scale to include networked supercomputers. The collaborative arrangement of computers working cooperatively to perform operations on data may be referred to as high performance computing (HPC).

Cluster computing offers the promise of systems with greatly increased computing performance relative to single processor computers by enabling a plurality of processors distributed across a network to work cooperatively to solve computationally intensive computing problems.

One of the problems attendant with some distributed cluster computing systems is that the frequent communications between distributed processors may impose a processing burden on the processors. The increase in processor utilization associated with the increasing processing burden may reduce the efficiency of the computing cluster for solving computing problems. The performance of cluster computing systems may be further compromised by bandwidth bottlenecks that may occur when sending and/or receiving data from processors distributed across the network.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for reliable datagram tunnels for clusters, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary distributed data processing communication system, which may be utilized in connection with an embodiment of the invention.

FIG. 2 is a block diagram of an exemplary system for reliable datagram tunnels for clusters, in accordance with an embodiment of the invention.

FIG. 3 is a block diagram of an exemplary connectionless datagram transmission, in accordance with an embodiment of the invention.

FIG. 4 is a block diagram of an exemplary transmitted UDP datagram in accordance with an embodiment of the invention.

FIG. 5 is a block diagram of an exemplary packet transfer via an established connection-oriented communications channel, in accordance with an embodiment of the invention.

FIG. 6 is a block diagram of an exemplary TCP packet in accordance with an embodiment of the invention.

FIG. 7 is a block diagram of an exemplary connectionless datagram receipt, in accordance with an embodiment of the invention.

FIG. 8 is a block diagram of an exemplary received UDP datagram in accordance with an embodiment of the invention.

FIG. 9 is a flowchart illustrating exemplary steps for reliable datagram tunnels for clusters, in accordance with an embodiment of the invention.

FIG. 10 is a flowchart illustrating an exemplary process for buffer management at an endpoint, in accordance with an embodiment of the invention.

### DETAILED DESCRIPTION OF THE INVENTION

Certain embodiments of the invention may be found in a method and system for reliable datagram tunnels for clusters. The invention may comprise a method and a system that may enable reliable communications between cooperating processors in a cluster computing environment while reducing the amount of processing burden in comparison to some conventional approaches to inter-processor communication among processors in the cluster. Various aspects of the invention may comprise a processor that establishes, from a local NIC, a communication channel between the local NIC and a remote NIC via a network. The processor may receive a datagram message from one of a plurality of local endpoints, communicatively coupled to the local NIC, without a dedicated connection. A datagram message may be delivered to one of a plurality of remote endpoints communicatively coupled to a remote NIC. The processor may communicate a datagram message from the local NIC to one of a plurality of remote endpoints via a one communication channel without establishing a dedicated connection between one of the plurality of local endpoints and one of the plurality of remote endpoints

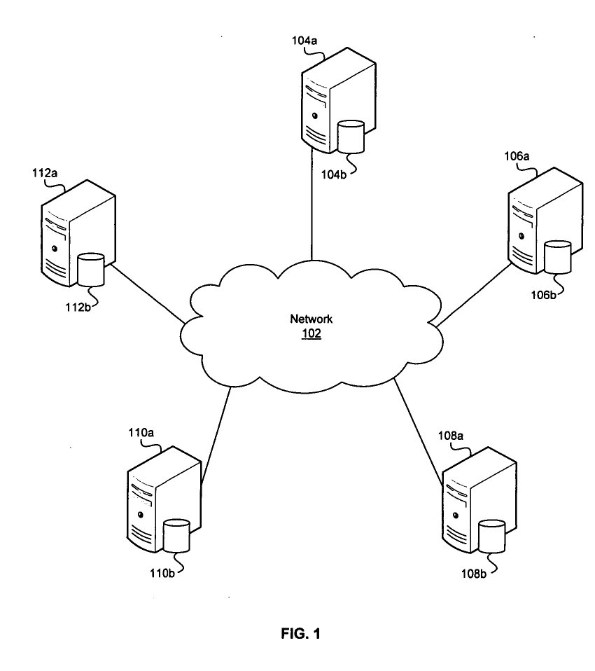

FIG. 1 illustrates an exemplary distributed data processing communication system, which may be utilized in connection with an embodiment of the invention. Referring to FIG. 1, there is shown a network 102, a plurality of computer systems 104a, 106a, 108a, 110a, and 112a, and a corresponding plurality of database applications 104b, 106b, 108b, 110b, and 112b. The computer systems 104a, 106a, 108a, 110a, and 112a may be coupled to the network 102. One or more of the computer systems 104a, 106a, 108a, 110a, and 112a may execute a corresponding database application 104b, 106b, 108b, 110b, and 112b, respectively, for example. In general, a plurality of software processes, for example a database application, may be executing concurrently at a computer system. The database applications may execute cooperatively in a distributed database processing environment. For example, the database application 104b executing at computer system 104a may issue a query to the database application 110b to access data stored at computer system 110a and send the accessed data to computer system 104 via the network 102. The database application 104b may subsequently process the received data.

In a distributed processing environment, such as in distributed database processing, for example, a database application, for example 104b, may communicate with one or more peer database applications, for example 106b, 108b, 110b, or 112b, via a network, for example, 102. The operation of the database application 104b may be considered to be coupled to the operation of one or more of the peer databases 106b, 108b, 110b, or 112b. A plurality of applications, for example database applications, which execute cooperatively, may form a cluster environment. A cluster environment may also be referred to as a cluster. The applications that execute cooperatively in the cluster environment may be referred to as cluster applications.

In some conventional cluster environments, a cluster application may communicate with a peer cluster application via a network by establishing a network connection between the cluster application and the peer application, exchanging information via the network connection, and subsequently terminating the connection at the end of the information exchange. An exemplary communications protocol that may be utilized to establish a network connection is the Transmission Control Protocol (TCP). An exemplary protocol that may be utilized to route information transported in a network connection across a network is the Internet Protocol (IP). An exemplary medium for transporting and routing information across a network is Ethernet, as defined by Institute of Electrical and Electronics Engineers (IEEE) resolution 802.3.

For example, database application 104b may establish a TCP connection to database application 110b. The database application 104b may initiate establishment of the TCP connection by sending a connection establishment request to the peer database application 110b. The connection establishment request may be routed from the computer system 104a, across the network 102, to the computer system 110a, via IP. The peer database application 110b may respond to the received connection establishment request by sending a connection establishment confirmation to the database application 104b. The connection establishment confirmation may be routed from the computer system 110a, across the network 102, to the computer system 104a, via IP.

After establishing the TCP connection, the database application 104b may issue a query to the database application 110b via the established TCP connection. In response to the query, the database application 110b may access data stored at computer system 110a. The database application 110b may subsequently send the accessed information to the database application 104b via the established TCP connection. The database application 104b may send an acknowledgement of receipt of the accessed data to the database application 110b via the established TCP connection. The database application 104b may terminate the established TCP connection by sending a connection terminate indication to the database application 110b.

In a cluster environment comprising N computer systems wherein P cluster applications, or software processes, are concurrently executing at each of the computer systems, the number of connections, NC, that may be established across a network at a given time instant may be:

$$NC = \frac{{P}^{2} N ( N - 1 )}{2} \qquad equation [ 1 ]$$

An exemplary cluster environment may comprise 8 computing systems, for example 104a, wherein 8 cluster applications, for example 104b, are executing at each of the 8 computer systems. In this regard, 1,712 connections may be established across a network, for example 102, at a given time instant.

Many of the connections established in some conventional cluster environments may be transient in nature. This may be true, for example, in transaction oriented cluster environments in which a cluster application may establish a connection when it needs to communicate with a peer cluster application across a network. At the completion of the communication or transaction, the connection may be terminated. At a subsequent time instant when the cluster application and peer cluster application need to communicate, the process of connection establishment, transaction, and connection termination may be repeated. The processing overhead required for maintaining large numbers of connections and/or frequent connection establishment and connection terminations may significantly decrease the processing efficiency of the cluster.

An alternative to the establishment of connections between cluster applications in a cluster environment may comprise enabling cluster applications to communicate without establishing connections. For example, database application 104b may utilize the user datagram protocol (UDP), instead of utilizing TCP, to communicate with the peer database application 110b. In this case, the database application could issue the query to the database application 110b via a protocol such as UDP, for example. The query may be routed across the network 102 via IP and delivered to the database application 110b. The database application 110b may subsequently access the data stored at computer system 110a. The database application 110b may subsequently send the accessed information to the database application 104b via a protocol such as UDP, for example.

A disadvantage of UDP in comparison to TCP is that UDP may be considered to be an unreliable method of transport. TCP may provide reliable methods by which a source application, that sends information to a destination application across a network, may receive a confirmation that the information was received by the destination application. UDP does not provide a method by which the source application may receive confirmation that information that was sent via a network, was received by the destination application. The utilization of unreliable methods of transport of information across a network may be undesirable.

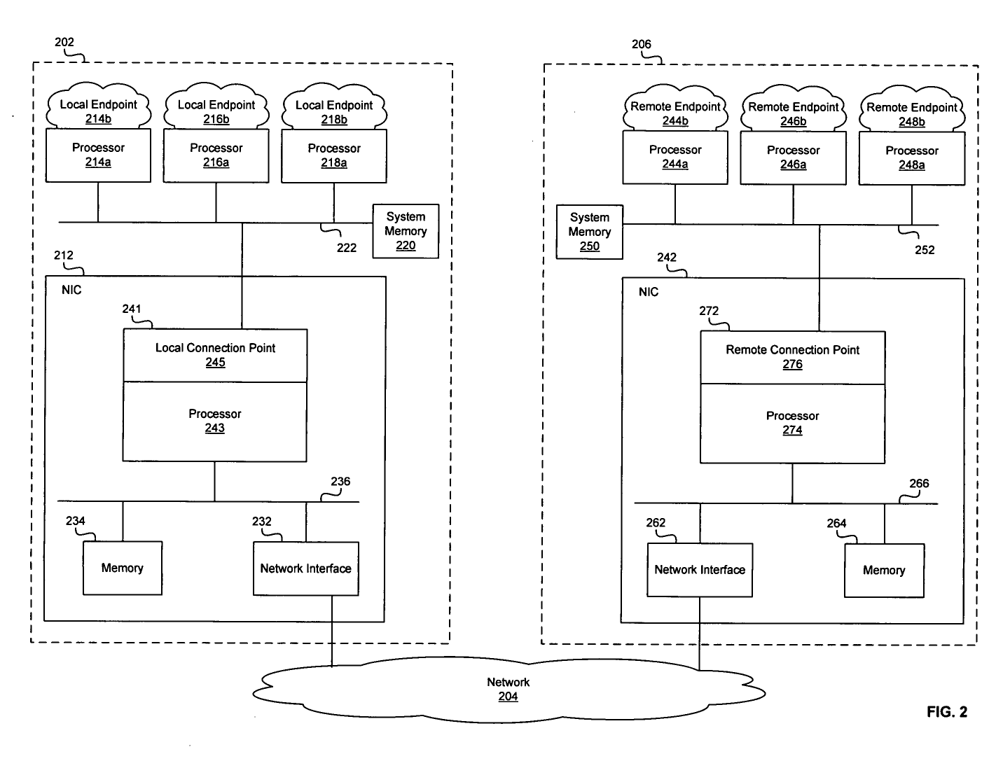

FIG. 2 is a block diagram of an exemplary system for reliable datagram tunnels for clusters, in accordance with an embodiment of the invention. Referring to FIG. 2, there is shown a network 204, and a local computer system 202, and a remote computer system 206. The local computer system 202 may comprise a network interface card (NIC) 212, a plurality of processors 214a, 216a and 218a, a plurality of local endpoints 214b, 216b, and 218b, a system memory 220, and a bus 222. The NIC 212 may comprise a TCP offload engine (TOE) 241, a memory 234, a network interface 232, and a bus 236. The TOE 241 may comprise a processor 243, and a local connection point 245. The remote computer system 206 may comprise a NIC 242, a plurality of processors 244a, 246a, and 248a, a plurality of remote endpoints 244b, 246b, and 248b, a system memory 250, and a bus 252. The NIC 242 may comprise a TOE 272, a memory 264, a network interface 262, and a bus 266. The TOE 272 may comprise a processor 274, and a remote connection point 276.

The processor 214a may comprise suitable logic, circuitry, and/or code that may be utilized to transmit, receive and/or process data. The processor 214a may execute applications code, for example a database application. The processor 214a may be coupled to a bus 222. The processor 214a may perform protocol processing when transmitting and/or receiving data via the bus.

In the transmitting direction, the protocol processing performed by the processor 214a may comprise receiving data from an application, for example, and encapsulating at least a portion of the received data in a protocol data unit (PDU) that may be constructed in accordance with a protocol specification, for example, UDP. The insertion of data from an application into a PDU may be referred to as encapsulation. In general, the insertion of a service data unit (SDU), received from a higher layer protocol, into a PDU may be referred to as encapsulation. The data from the application, or SDU may be referred to as a payload within the PDU. The UDP PDU may be referred to as a UDP datagram or datagram. The protocol processing may comprise constructing one or more PDU header fields comprising a source network address, source and/or destination port identifiers, and/or computation of error check fields. The PDU may be constructed by appending the PDU header fields to the payload. The PDU may be transmitted to the NIC 212 via the bus 222.

In the receiving direction the protocol processing performed by the processor 214a may comprise receiving PDUs via the bus 222 that were received via the NIC 212. The processor 214a may perform protocol processing that de-encapsulates at least a portion of the PDU received from the NIC 212, via the bus 222 in accordance with a protocol specification, to extract data. The extraction of one or more PDU header fields in a received PDU may be referred to as de-encapsulation. A payload may be retrieved from the PDU if all of the PDU header fields are removed from the PDU, for example. The protocol processing may comprise verifying one or more PDU header fields comprising the destination network address, source and/or destination port identifiers, and/or computations to detect and/or correct bit errors in the received PDU. The data may be subsequently processed by an application.

The local endpoint 214b may comprise protocol processing code that may be executable by the processor 214a. The processor 216a may be substantially as described for the processor 214a. The local endpoint 216b may be substantially as described for the local endpoint 214b. The processor 218a may be substantially as described for the processor 214a. The local endpoint 218b may be substantially as described for the local endpoint 214b.

The system memory 220 may comprise suitable logic, circuitry, and/or code that may be utilized to store, or write, and/or retrieve, or read, information, data, and/or executable code. The system memory 220 may comprise a plurality of memory technologies such as random access memory (RAM). The system memory 220 may be utilized to store and/or retrieve data and/or PDUs that may be processed by one or more of the processors 214a, 216a, and 218a. The memory 220 may store information such as code that may be executed by the one or more of the processors 214a, 216a, and 218a.

The network interface chip/card (NIC) 212 may comprise suitable circuitry, logic and/or code that may enable transmission and reception of data from a network, for example, an Ethernet network. The NIC may be coupled to the network 204. The NIC 212 may process data received and/or transmitted via the network 204. The NIC 212 may be coupled to the bus 222. The NIC 212 may process data received may process data received and/or transmitted via the bus 222. In the transmitting direction, the NIC 212 may receive data via the bus 222. The NIC 212 may process the data received via the bus 222 and transmit the processed data via the network 204. In the receiving direction, the NIC 212 may receive data via the network 204. The NIC 212 may process the data received via the network 204 and transmit the processed data via the bus 222.

The TOE 241 may comprise suitable logic, circuitry, and/or code to receive data via the bus 222 from one or more processors 214a, 214b, or 214c, and to perform protocol processing and to construct one or more packets and/or one or more frames. In the transmitting direction the TOE 241 may receive data via the bus 222. The TOE 241 may perform protocol processing that encapsulates at least a portion of the received data in a protocol data unit (PDU) that may be constructed in accordance with a protocol specification, for example, TCP. The TCP PDU may be referred to as a TCP packet, or packet. The protocol processing may comprise constructing one or more PDU header fields comprising source and/or destination network addresses, source and/or destination port identifiers, and/or computation of error check fields. The PDU may be transmitted via the bus 236 for subsequent transmission via the network 204.

In the receiving direction the TOE 241 may receive PDUs via the bus 236 that were previously received via the network 204. The TOE 241 may perform protocol processing that de-encapsulates at least a portion of the PDU received from the network 204, via the bus 236 in accordance with a protocol specification, to extract data. The protocol processing may comprise verifying one or more PDU header fields comprising source and/or destination network addresses, source and/or destination port identifiers, and/or computations to detect and/or correct bit errors in the received PDU. The data may be subsequently processed by the TOE 241 any transmitted via the bus 222.

The TOE 241 may cause at least a portion of a PDU that was received via the bus 236, which was previously received via the network 204, to be stored in the memory 234. The TOE 241 may cause at least a portion of a PDU, which is to be subsequently transmitted via the network 204, to be stored in the memory 234. The TOE 241 may cause an intermediate result, comprising a PDU or data, which is processed at least in part by the TOE 241, to be stored in the memory 234.

The memory 234 may comprise suitable logic, circuitry, and/or code that may be utilized to store, or write, and/or retrieve, or read, information, data, and/or executable code. The memory 234 may comprise a plurality of memory technologies such as random access memory (RAM). The memory 234 may be utilized to store and/or retrieve data and/or PDUs that may be processed by the TOE 241. The memory 234 may store information such as code that may be executed by the TOE 241.

The network interface 232 may comprise suitable logic, circuitry, and/or code that may be utilized to transmit and/or receive PDUs via a network 204. The network interface may be coupled to the network 204. The network interface may be coupled to the bus 236. The network interface 232 may receive bits via the bus 236. The network interface 232 may subsequently transmit the bits via the network 204 that may be contained in a representation of a PDU by converting the bits into electrical and/or optical signals, with timing parameters, and with signal amplitude, energy and/or power levels as specified by an appropriate specification for a network medium, for example, Ethernet. The network interface 232 may also transmit framing information that identifies the start and/or end of a transmitted PDU.

The network interface 232 may receive bits that may be contained in a PDU received via the network 204 by detecting framing bits indicating the start and/or end of the PDU. Between the indication of the start of the PDU and the end of the PDU, the network interface 232 may receive subsequent bits based on detected electrical and/or optical signals, with timing parameters, and with signal amplitude, energy and/or power levels as specified by an appropriate specification for a network medium, for example, Ethernet. The network interface 232 may subsequently transmit the bits via the bus 236.

The processor 243 may comprise suitable logic, circuitry, and/or code that may be utilized to perform at least a portion of the protocol processing tasks within the TOE 241.

The local connection point 245 may comprise a computer program that comprises at least one code section that may be executable by the processor 243 for causing the processor 243 to perform steps comprising protocol processing, in accordance with an embodiment of the invention.

The processor 244a may be substantially as described for the processor 214a. The processor 244a may be coupled to the bus 252. The local endpoint 244b may be substantially as described for the local endpoint 214b. The processor 246a may be substantially as described for the processor 214a. The processor 246a may be coupled to the bus 252. The local endpoint 246b may be substantially as described for the local endpoint 214b. The processor 248a may be substantially as described for the processor 214a. The processor 248a may be coupled to the bus 252. The local endpoint 248b may be substantially as described for the local endpoint 214b. The system memory 250 may be substantially as described for the system memory 220. The system memory 250 may be coupled to the bus 252. The NIC 242 may be substantially as described for the NIC 212. The NIC 242 may be coupled to the bus 252. The TOE 272 may be substantially as described for the TOE 241. The TOE 272 may be coupled to the bus 252. The TOE 272 may be coupled to the bus 266. The network interface 262 may be substantially as described for the network interface 232. The network interface 262 may be coupled to the bus 266. The memory 264 may be substantially as described for the memory 234. The memory 264 may be coupled to the bus 266. The processor 274 may be substantially as described for the processor 243. The remote connection point 276 may be substantially as described for the local connection point 245.

In operation, for connection oriented protocols, such as TCP, the TOE 241 may originate a connection prior to transmitting PDUs via the network. The connection may comprise a communications channel via the network 204 between a local computer system 202 and a remote computer system 206. A local TOE 241 may transmit a connection establishment request message to a remote TOE 272. The connection establishment message may be transmitted in a connection request TCP packet generated by the TOE 241. The connection request TCP packet may comprise a header and a payload. The payload may comprise the connection establishment message. The header may comprise a source port field, a source network address field, a destination port field, and a destination network address field. The source port field may be selected by the local connection point 245. The source network address field may be associated with the local connection point 245. The destination network address field may be associated with the remote connection point 276. The destination port field may be utilized by the remote connection point 276 to execute code that may cause the remote connection point to execute steps to establish a communications channel between the local connection point 245 and the remote connection point 276 via the network 204.

The processor 243 may utilize TCP, for example, to transmit the connection request TCP packet, via the bus 236, to the network interface 232. The processor 243 may also utilize IP, for example, to enable the connection request TCP packet to be routed, via the network, to the remote computer system 206, and subsequently to the remote connection point 276. The network interface 232 may transmit the connection request TCP packet to the network 204. The network 204 may utilize at least a portion of the header information within the connection request TCP packet to deliver the connection request TCP packet to the remote computer system 206. The network interface 262 within the NIC 242 of the remote computer system 206 may receive the connection request TCP packet from the network 204. The network interface 262 may transmit the connection request TCP packet to the TOE 272 via the bus 266.

Upon receipt of the connection request TCP packet by the TOE 272, the remote connection point 276 may cause the processor 274 within the TOE 272 to process the connection request TCP packet. The processor 274 may de-encapsulate at least a portion of the connection request TCP packet. At least a portion of the payload of the connection request TCP packet may comprise the connection establishment request from the TOE 241. The processor 274 may utilize the source network address field from the connection request TCP packet to identify the TOE 241 as being the source of the connection establishment request. The processor 274 may utilize the destination network address and/or destination port fields from the connection establishment TCP packet respond the to connection establishment request message by sending a connection establishment reply message to the TOE 241.

The remote TOE 272 may respond by transmitting a connection establishment reply message to the local TOE 241. The connection establishment reply message may be encapsulated within a connection reply TCP packet. The source port field in the connection reply TCP packet may comprise at least a portion of the destination port field in the connection request TCP packet. The source network address field in the connection reply TCP packet may comprise at least a portion of the destination network address field in the connection request TCP packet. The destination network address field in the connection reply TCP packet may comprise at least a portion of the source network address field in the TCP request packet. The destination port field in the connection reply TCP packet may comprise at least a portion of the source port field in the TCP request packet. The payload in the connection reply TCP packet may comprise the connection establishment reply message. Once established, the communications channel between the local TOE 241 and the remote TOE 272 may comprise a tunnel that may be utilized to reliably transport datagrams between at least a portion of local and/or remote endpoints in a cluster.

In various embodiments of the invention the tunnel may provide a local endpoint 214b within a cluster with a reliable method for sending a datagram across a network 204 that may be received by a peer remote endpoint 244b within the cluster. By utilizing the tunnel, the local endpoint 214b may realize the benefits of reliable transport of datagrams across the network 204 when exchanging information with a plurality of peer endpoints a cluster without incurring the overhead attendant with establishing a separate connection at the transport protocol layer, for example, between the local endpoint 214b and each of the plurality of peer endpoints. The local endpoint 214b may send a datagram without establishing a connection, at the transport protocol layer for example, to the local connection point 245. The local connection point 245 may send the datagram via the tunnel established at the transport protocol layer, for example, across the network 204 and to the remote connection point 276. The remote connection point 276 may send the datagram, without establishing a connection at the transport protocol layer, for example, to the remote endpoint 244b.

The local TOE 241 and the remote TOE 272 may each maintain state information related to the communications channel between the local computer system 202, and the remote computer system 206. The state information may comprise a connection identifier that corresponds to the connection via the network 204. The PDUs transmitted by either the local computer system 202 or the remote computer system 206 may comprise the corresponding connection identifier that corresponds to the connection via the network 204.

The connection identifier may comprise a local network address, a local port, a remote network address and a remote port. The local network address may correspond to an address, associated with the local connection point, utilized in connection with a network protocol. The network protocol, for example the Internet Protocol (IP), may be utilized to route PDUs, or packets, between the local connection point 245, and the remote connection point 276.

In various embodiments of the invention, a local database application executing at the processor 214a in the local computer system 202 may attempt to issue a query to a peer database application executing at the processor 244a in the remote computer system 206. The local endpoint 214b may cause the processor 214a to retrieve data from system memory 220 comprising the query from the local database application. The processor 214a may perform protocol processing that encapsulates the retrieved data in a PDU. The PDU may comprise a source port that identifies the processor 214a as the originator of the PDU comprising the query. The local endpoint 214b may also cause the processor 214a to select the processor 244a as the destination for the query. The PDU may comprise a destination port that identifies the processor 244a as the destination. The local endpoint 214b may cause the processor 214a to select a source network address that is associated with a communications channel between the local connection point 245 and the remote connection point 276. The processor may utilize UDP, for example, to transmit the PDU, comprising the source network address, source port, destination port, and payload, via the bus 222 to the TOE 241. At least a portion of the payload may comprise data from the query of the local database application. The protocol utilized for transmission between the processor 214a and the TOE 241, for example UDP, may be connectionless.

At the NIC 212, the PDU may be received by the TOE 241 via the bus 222. The local connection point 245 may cause the processor 243 to de-encapsulate at least a portion of the received PDU. At least a portion of the received PDU payload comprising the query may be de-encapsulated. The processor 243 may utilize the source network address field in the received PDU to determine at least a portion of a connection identifier associated with the communications channel. The portion may comprise a source network address associated with the local connection point 245, and a destination network address associated with the remote connection point 276. The processor 243 may also utilize the source port and/or destination port fields from the received PDU to determine at least a subsequent portion of the connection identifier. The source port may identify the processor 214a as the source of the query. The destination port may identify the processor 244a as the destination of the query. The processor 243 may construct a network PDU comprising a header and a payload. The network PDU header may comprise a source network address field, a source port field, a destination network address field, and a destination port field. The network PDU payload may comprise at least a portion of the payload contained in the received PDU. The processor 243 may utilize TCP, for example, to transmit the network PDU, via the bus 236, to the network interface 232. The processor 243 may also utilize IP, for example, to enable the network PDU to be routed, via the network, to the remote computer system 206, and subsequently to the remote connection point 276. The TCP transmission between the local connection point 245 and the remote connection point 276 may be connection oriented. The corresponding communications channel may be referred to as a TCP connection. In some parlance, the communications channel may be referred to, somewhat inaccurately, as a TCP/IP connection.

The network interface 232 may transmit the network PDU to the network 204 via a network interface medium, for example, an Ethernet cable. The network interface medium may be coupled to an access router, or other switching device, for example, within the network 204. The network 204 may utilize at least a portion of the header information within the network PDU to deliver the network PDU to the remote computer system 206. The network interface 262 within the NIC 242 of the remote computer system 206 may receive the network PDU from the network 204 via a network interface medium. The network interface medium may be, but is not limited to being, the same as the network interface medium utilized by the network interface 232 within the local computer system 202. The network interface 262 may transmit the network PDU to the processor 274 via the bus 266.

Upon receipt of the network PDU by the processor 274, the remote connection point 276 may cause the processor 274 to process the network PDU. The processor may de-encapsulate at least a portion of the network PDU. At least a portion of the payload of the network PDU may comprise the query from the database application executing at the processor 214a. The processor may utilize the source network address and/or source port fields from the network PDU to identify the processor 214a as being the source of the query. The processor may utilize the destination network address and/or destination port fields from the network PDU to identify the processor 244a as being the destination of the query. The remote connection point 276 may cause the processor 274 to construct a delivered PDU that comprises a destination network address field, a source port field, a destination port field, and a payload field. The processor 274 may encapsulate at least a portion of the payload field of the network PDU in a payload field of a delivered PDU. The destination address field in the delivered PDU may comprise at least a portion of the destination address field in the network PDU. The destination port field in the delivered PDU may comprise at least a portion of the destination port field in the network PDU. The source port field in the delivered PDU may comprise at least a portion of the source port field in the network PDU. The TOE 272 may utilize a protocol such as UDP, for example, to transmit the delivered PDU to the processor 244a via the bus 252.

Upon receipt of the delivered PDU, the remote endpoint 244b may cause the processor 244a to de-encapsulate the delivered PDU to retrieve the query originally sent by the processor 214a. The processor 244a may determine that the processor 214a originally sent the query based on the source port field and/or destination network address field in the delivered PDU. The remote endpoint 244b may cause the processor 244a to send data comprising the query to the system memory 250. The query may subsequently be retrieved from the system memory 250 by the peer database application.

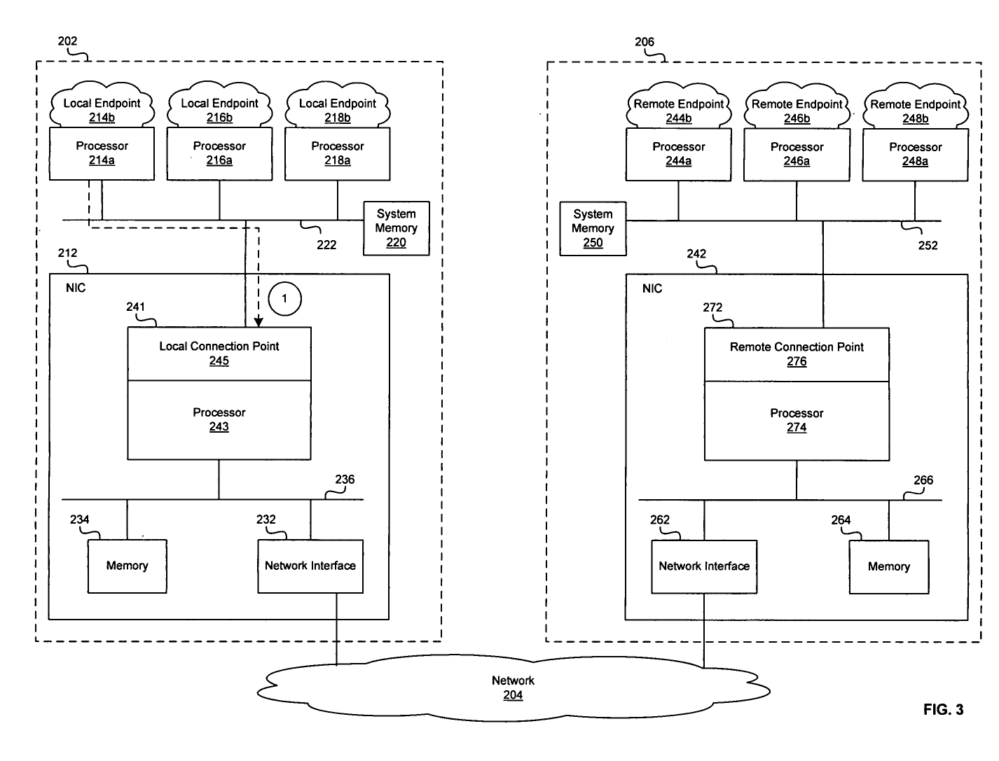

FIG. 3 is a block diagram of an exemplary connectionless datagram transmission, in accordance with an embodiment of the invention. Referring to FIG. 3, there is shown a network 204, and a local computer system 202, and a remote computer system 206. The local computer system 202 may comprise a network interface card (NIC) 212, a plurality of processors 214a, 216a and 218a, a plurality of local endpoints 214b, 216b, and 218b, a system memory 220, and a bus 222. The NIC 212 may comprise a TCP offload engine (TOE) 241, a memory 234, a network interface 232, and a bus 236. The TOE 241 may comprise a processor 243, and a local connection point 245. The remote computer system 206 may comprise a NIC 242, a plurality of processors 244a, 246a, and 248a, a plurality of remote endpoints 244b, 246b, and 248b, a system memory 250, and a bus 252. The NIC 242 may comprise a TOE 272, a memory 264, a network interface 262, and a bus 266. The TOE 272 may comprise a processor 274, and a remote connection point 276.

FIG. 3 comprises an annotation of FIG. 2 to illustrate the path of, for example, a UDP datagram that may be transmitted by the local endpoint 214b to the local connection point 245 via the bus 222. The path, segment 1, is indicated in FIG. 3 by the number “1.” Segment 1 may comprise a connectionless path. The datagram may comprise a source network address that may indicate to the local connection point 245 that the datagram may be de-encapsulated and at least a portion of the datagram subsequently encapsulated in a packet. The packet may be transmitted, via the network 204, utilizing a TCP connection as indicated by the source network address. The datagram may also comprise a source port field that indicates the local endpoint 214b. The source port field of the packet may comprise at least a portion of the source port field from the datagram. The datagram may also comprise a destination port field that indicates the remote endpoint 244b. The destination port field of the packet may comprise at least a portion of the destination port field from the datagram. The payload of the datagram may comprise information that may be transmitted from the local endpoint 214b to the remote endpoint 244b. The payload of the packet may comprise at least a portion of the payload of the datagram.

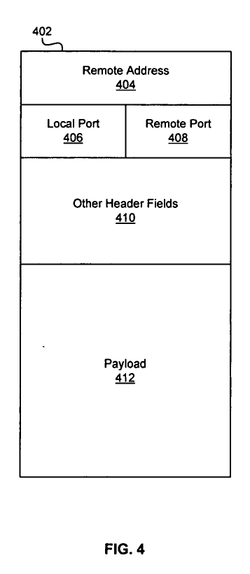

FIG. 4 is a block diagram of an exemplary transmitted UDP datagram in accordance with an embodiment of the invention. Referring to FIG. 4, there is shown an exemplary UDP datagram 402, a remote address field 404, a local port field 406, a remote port field 408, other header fields 410, and a payload 412. Referring to the datagram referred to in segment 1 (FIG. 3), the remote address field 404 may comprise the destination network address field, the local port field 406 may comprise the source port field, the remote port field 408 may comprise the destination port field, and the payload field 412 may comprise the payload. The other header fields 410 may be utilized in connection with protocol processing in accordance with the UDP as specified by the applicable Internet Engineering Task Force (IETF) specifications, for example.

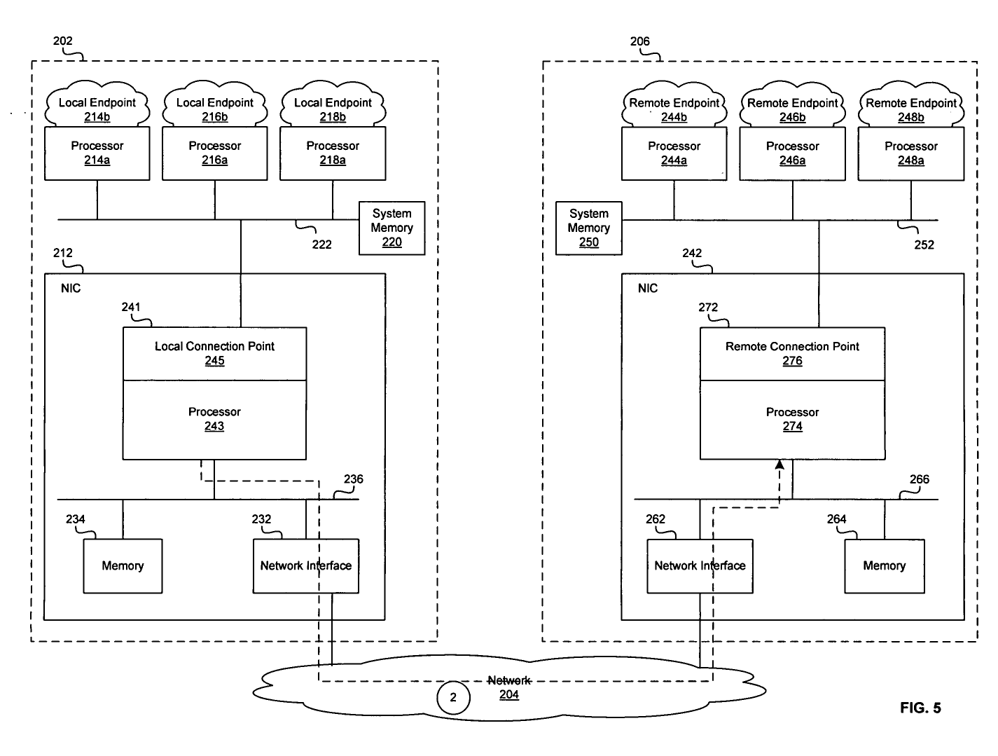

FIG. 5 is a block diagram of an exemplary packet transfer via an established connection-oriented communications channel, in accordance with an embodiment of the invention. Referring to FIG. 5, there is shown a network 204, and a local computer system 202, and a remote computer system 206. The local computer system 202 may comprise a network interface card (NIC) 212, a plurality of processors 214a, 216a and 218a, a plurality of local endpoints 214b, 216b, and 218b, a system memory 220, and a bus 222. The NIC 212 may comprise a TCP offload engine (TOE) 241, a memory 234, a network interface 232, and a bus 236. The TOE 241 may comprise a processor 243, and a local connection point 245. The remote computer system 206 may comprise a NIC 242, a plurality of processors 244a, 246a, and 248a, a plurality of remote endpoints 244b, 246b, and 248b, a system memory 250, and a bus 252. The NIC 242 may comprise a TOE 272, a memory 264, a network interface 262, and a bus 266. The TOE 272 may comprise a processor 274, and a remote connection point 276.

FIG. 5 comprises an annotation of FIG. 2 to illustrate the path of a TCP packet that may be transmitted by the local connection point 245 to the remote connection point 276 via the network 204. The path, segment 2, is indicated in FIG. 5 by the number “2.” Segment 2 may comprise a connection-oriented path. The connection-oriented path may comprise a tunnel that may be utilized to reliably transport datagrams. Segment 2 comprises the transmitting of the packet from the TOE 241 to the network interface 232 via the bus 236, the subsequent transmitting of the packet from the network interface 232 via the network 204 to the network interface 262. Segment 2 further comprises the transmitting of the packet from the network interface 262 via the bus 266 to the remote connection point 272 within the TOE 272.

The processor 243 may select segment 2, from a plurality of TCP connections originating at the local connection point 245, based on the remote address field 404 in the datagram transmitted via segment 1 (FIG. 3). In this regard, at least one source network address may be associated with a corresponding at least one destination network address, in various embodiments of the invention. The local network address field, local port field, destination network address field, and the destination port field may be utilized to route the packet across the network between the network interface 232 and the network interface 262.

The remote connection point 276 may utilize the local network address field within the TCP packet to identify the local connection point 245 that transmitted the packet via the network 204. The remote connection point 276 may further utilize the local port field within the TCP packet to identify the local endpoint 214b. The remote connection 276 may utilize the remote port field to identify the remote endpoint 244b. The packet may be de-encapsulated and at least a portion of the packet may be subsequently encapsulated within a datagram.

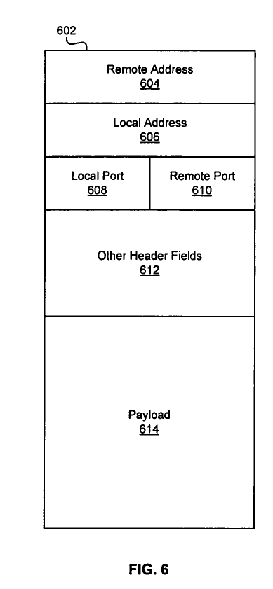

FIG. 6 is a block diagram of an exemplary TCP packet in accordance with an embodiment of the invention. Referring to FIG. 6, there is shown a TCP packet 602, a remote address field 604, a local address field 606, a local port field 608, a remote port field 610, other header fields 612, and a payload 614. Referring to the packet referred to in segment 2 (FIG. 5), remote address field 604 may comprise the destination address field, the local address field 606 may comprise the source network address field, the local port field 608 may comprise the source port field, the remote port field 610 may comprise the destination port field, and the payload field 614 may comprise the payload. The other header fields 612 may be utilized in connection with protocol processing in accordance with the TCP as specified by the applicable IETF specifications.

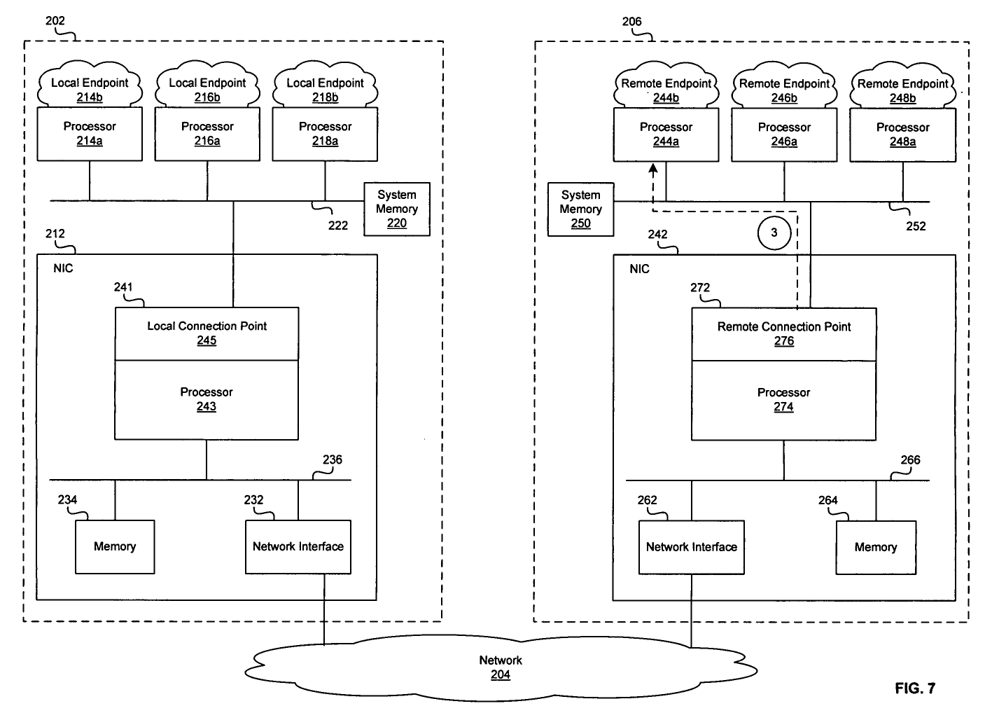

FIG. 7 is a block diagram of an exemplary connectionless datagram receipt, in accordance with an embodiment of the invention. Referring to FIG. 7, there is shown a network 204, and a local computer system 202, and a remote computer system 206. The local computer system 202 may comprise a network interface card (NIC) 212, a plurality of processors 214a, 216a and 218a, a plurality of local endpoints 214b, 216b, and 218b, a system memory 220, and a bus 222. The NIC 212 may comprise a TCP offload engine (TOE) 241, a memory 234, a network interface 232, and a bus 236. The TOE 241 may comprise a processor 243, and a local connection point 245. The remote computer system 206 may comprise a NIC 242, a plurality of processors 244a, 246a, and 248a, a plurality of remote endpoints 244b, 246b, and 248b, a system memory 250, and a bus 252. The NIC 242 may comprise a TOE 272, a memory 264, a network interface 262, and a bus 266. The TOE 272 may comprise a processor 274, and a remote connection point 276.

FIG. 7 comprises an annotation of FIG. 2 to illustrate the path of a UDP datagram that may be received by the remote endpoint 244b from the remote connection point 276 via the bus 252. The path, segment 3, is indicated in FIG. 7 by the number “3.” Segment 3 may comprise a connectionless path. The datagram may comprise a destination port that may be utilized by the remote connection point 276 to select a remote endpoint 244b. The destination port field within the datagram may comprise at least a portion of the destination port field from the corresponding packet. The datagram may comprise a destination network address that may indicate the remote connection point 276 that transmitted the datagram via the bus 252 to the remote endpoint 244b. The destination network address field within the datagram may comprise at least a portion of the destination network address field from the corresponding packet. The destination network address field may also indicate the communications channel that was utilized to transport information, contained in the datagram, between the local connection point 245 and the remote connection point 276, via the network 204. The datagram may comprise a source port that may indicate the local endpoint 214b. The source port field within the datagram may comprise at least a portion of the source port field from the corresponding packet. The datagram may comprise a payload that comprises at least a portion of information transmitted by the local endpoint 214b. The payload within the datagram may comprise at least a portion of the payload from the corresponding packet. The remote endpoint 244b may subsequently utilize information contained within the destination network address field and/or source port field from the received datagram to subsequently transmit information to the local endpoint 214, via the communications channel.

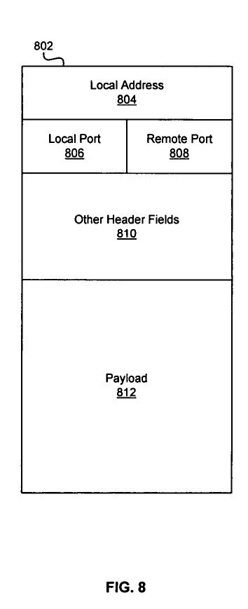

FIG. 8 is a block diagram of an exemplary received UDP datagram in accordance with an embodiment of the invention. Referring to FIG. 8, there is shown an exemplary UDP datagram 802, a local address field 804, a local port field 806, a remote port field 808, other header fields 810, and a payload 812. Referring to the datagram referred to in segment 3 (FIG. 7), the local address field 804 may comprise the destination network address field, the local port field 806 may comprise the source port field, the remote port field 808 may comprise the destination port field, and the payload field 812 may comprise the payload. The other header fields 810 may be utilized in connection with protocol processing in accordance with the UDP as specified by the applicable IETF specifications, for example.

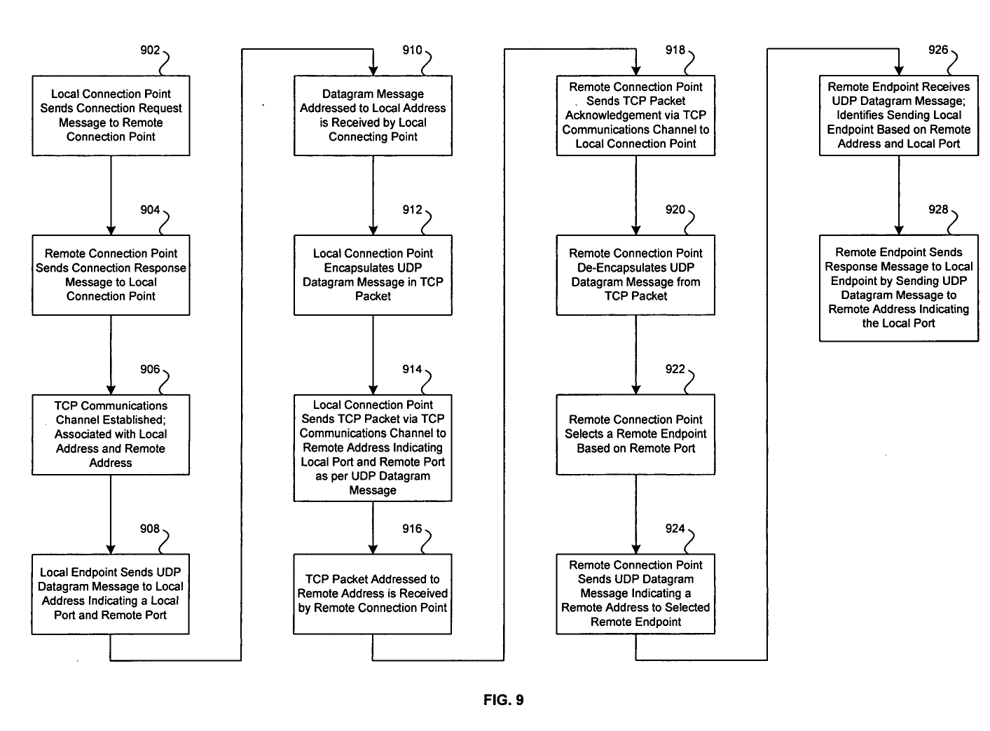

FIG. 9 is a flowchart illustrating exemplary steps for reliable datagram tunnels for clusters, in accordance with an embodiment of the invention. Referring to FIG. 9, in step 902, a local connection point 245 may send a connection request message to the remote connection point 276. In step 904, the remote connection point 276 may send a connection response message to the local connection point 245. In step 906, a connection-oriented TCP communications channel may be established. The communications channel maybe associated with a local network address and/or a remote network address. The local network address may be associated with the local connection point 245. The remote network address may be associated with the remote connection point 276.

In step 908, the local endpoint 214b may send a UDP datagram message, for example, to the local network address. The exemplary UDP datagram message may indicate a local port and/or remote port. In step 910, the datagram message, address to the local network address, may be delivered to the local connecting point 245. In step 912, the local connection point 245 may encapsulate at least a portion of the datagram message in a TCP packet. In step 914, the local connection point 245 may send a TCP packet, according to the remote network address field, via the TCP communications channel. The TCP communications channel may be selected by the local connection point 245 based on the local network address. The TCP packet may further comprise a local port field and/or a remote port field in accordance with corresponding fields in the exemplary UDP datagram message.

In step 916, the TCP packet addressed according to the remote network address field may be received by the remote connection point 276. In step 918, the remote connection point 276 may send a TCP packet acknowledgement to the local connection point 245 via the TCP communications channel. The TCP packet acknowledgement may be utilized by the local connection point 245 to update state information associated with the TCP communications channel. In step 920, the remote connection point 276 may de-encapsulate at least a portion of the original exemplary UDP datagram message that was encapsulated within the TCP packet in step 912. At least a portion of the information de-encapsulated may be encapsulated within a subsequent UDP datagram, for example. In step 922, the remote connection point 276 may select at least one remote endpoint, from a plurality of remote endpoints, based on the remote port field within the received TCP packet.

In step 924, the remote connection point 276 may send the subsequent UDP datagram message, for example, to the selected remote endpoint 244b. The subsequent UDP datagram message, for example, may indicate a remote network address. The remote network address may be associated with the remote connection point 276. The remote network address may further be associated with the TCP communications channel. In step 926, the remote endpoint 244b may receive the subsequent UDP datagram message, for example. The subsequent UDP datagram message, for example, may identify the sending local endpoint 214b based on the remote network address and/or the local port field contained within the subsequent UDP datagram message, for example. In step 928, the remote endpoint 244b may send a response message to the local endpoint 214b by sending a response UDP datagram message, for example. The local network address field within the response UDP datagram message, for example, may comprise the remote network address associated with the remote connection point 276. The local port field within the exemplary response UDP datagram message may identify the remote endpoint 244b. The remote port field within the exemplary response UDP datagram message may identify the local endpoint 214b:

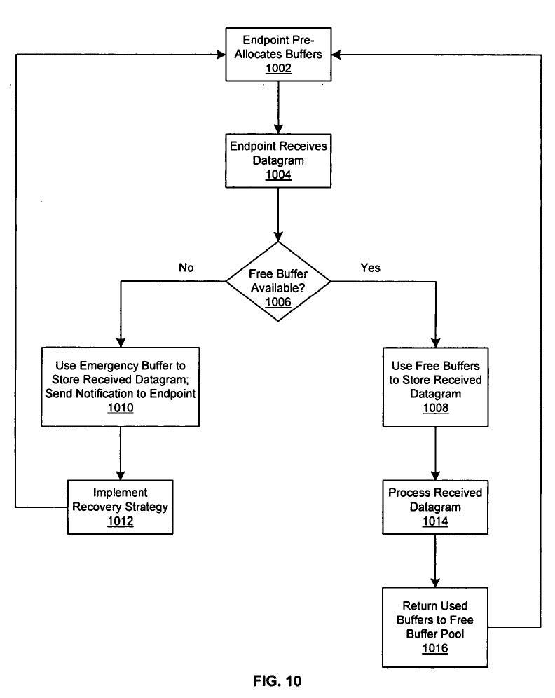

FIG. 10 is a flowchart illustrating an exemplary process for buffer management at an endpoint, in accordance with an embodiment of the invention. In various embodiments of the invention, an endpoint, such as the remote endpoint 244b, may allocate a portion of system memory 250. An exemplary embodiment of an endpoint may be a database application 110b. The allocated portion of the system memory 250 may be utilized to provide one or more buffers to store one or more received datagrams. In step 1002, an endpoint may pre-allocate buffers. The pre-allocated buffers may be associated with a port identifier, for example a local port, that is associated with the endpoint. The pre-allocated buffers may form a free buffer pool. In step 1004, at least a portion of the datagram may be received by the endpoint. Step 1006 may determine if there is a sufficient quantity of buffers remaining in the free buffer pool to store the received datagram. The number of buffers utilized to store the received datagram may depend upon the size of the datagram, as measured in bytes for example, but a sufficient quantity of buffers may be utilized to store at least a header portion of the datagram. An application that may subsequently process the datagram may allocate additional buffers to receive the entire datagram. If there is a sufficient number of buffers to receive the datagram, in step 1008, the endpoint may utilize a portion of the free buffer pool to store the received datagram. For example, the remote endpoint 244b may utilize a portion of a free buffer pool to store a datagram received via segment 3 (FIG. 7). A utilized buffer may be removed from the free buffer pool. This may reduce the number of buffers remaining in the free buffer pool.

If there is not a sufficient number of buffers to receive the datagram as determined in step 1006, in step 1010, a notification may be sent to the endpoint. Emergency buffers may be utilized to store the received datagram. The emergency buffers may comprise additional memory beyond that preallocated for the free buffer pool. The received datagram may be subsequently dropped. The notification may indicate that there was an insufficient number of buffers in the free buffer pool. The notification may be generated by the operating system or execution environment in which the endpoint is executing. Examples of operating systems may include Unix, and Linux. In step 1012, the endpoint may implement a recovery strategy suitable for the application associated with the endpoint receiving the notification, for example a database application. In some implementations, the recovery strategy may result in a receiving remote endpoint 244b communicating a request to sending local endpoint 214b that the discarded datagram be resent.

In step 1014, following step 1008, the endpoint may process the received datagram. In step 1016, the endpoint may return the buffers utilized by the datagram to the free buffer pool. This may increase the number of buffers remaining the free buffer pool. Step 1004 may follow step 1012 or step 1016.

Aspects of a system for transporting information via a communications system may include a processor 243 that establishes, from a local network interface card (NIC) 212, at least one communication channel between the local NIC 212 and at least one remote NIC 242 via at least one network 204. The processor 243 may receive, by the local NIC 212, at least one datagram message from one of a plurality of local endpoints, communicatively coupled to the local NIC 212, without a dedicated connection at the transport protocol layer for example. At least a portion of at least one datagram message may be delivered to at least one of a plurality of remote endpoints communicatively coupled to at least one remote NIC 242. The processor 243 may communicate at least a portion of the at least one datagram message from the local NIC 212 to at least one of a plurality of remote endpoints via at least one communication channel without establishing a dedicated connection, at the transport protocol layer for example, between the one of a plurality of local endpoints and the at least one of a plurality of remote endpoints.

The processor 243 may receive from one of a plurality of local endpoints at least one datagram message including at least one of the following: a remote address, a local port, a remote port, and/or a payload. The at least one communications channel may be selected based on the remote address. One of a plurality of local endpoints may be identified based on the local port. At least one of a plurality of remote endpoints may be identified based on the remote port. The processor 243 may receive at least one acknowledgement in response to the communicated one or more datagram messages without subsequently communicating the one or more acknowledgements to one of a plurality of local endpoints.

Establishing at least one communications channel by the local NIC 212 may further comprise communicating a connection request message from the local NIC 212 to the remote NIC 242, and receiving, by the local NIC 212, a corresponding connection response message from the remote NIC 242. The connection request message may include a local address, and/or a corresponding local port. The local address and the corresponding local port may correspond to one of the at least one communications channel. The connection response message may include a remote address, and/or a corresponding remote port. The remote address and the corresponding remote port may correspond to one of the plurality of remote endpoints. At least a portion of the datagram message may be appended with a remote address and a corresponding remote port that corresponds to the remote NIC 242.

The at least one communications channel may utilize a transmission control protocol (TCP) connection. One of the plurality of local endpoints may communicate via a protocol such as the user datagram protocol (UDP), for example. One of the plurality of local endpoints may communicate with at least one of the plurality of remote endpoints via a cutthrough communications channel that bypasses at least one communications channel. In this case, a local endpoint 214b and a remote endpoint 244b may establish a TCP connection that may be independent of an established communication channel between the NIC 212 and the remote NIC 242.

Aspects of a machine-readable storage having stored thereon, a computer program having at least one code section for enabling transporting of information via a communications system. The at least one code section may be executable by a machine for causing the machine to perform steps that may comprise enabling establishment from a local network interface card (NIC) 212, at least one communication channel between the local NIC 212 and one or more remote NICS such as NIC 242 via at least one network 204. The machine readable code may comprise code for enabling receiving, by the local NIC 212, at least one datagram message from one of a plurality of local endpoints communicatively coupled to the local NIC 212 without a dedicated connection at the transport protocol layer for example. At least a portion of at least one datagram message may be delivered to at least one of a plurality of remote endpoints communicatively coupled to one or more remote NICS such as remote NIC 242. The machine-readable code may comprise code that enables communication of at least a portion of the at least one datagram message from the local NIC 212 to at least one of a plurality of remote endpoints via at least one communication channel without establishing a dedicated connection at the transport protocol layer. For example, no connection is established between any of plurality of local endpoints and any of the plurality of remote endpoints.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for transporting information via a communications system, the method comprising:
establishing at least one communication channel between a local network interface card (NIC) and at least one remote NIC via at least one network;
receiving via said local NIC at least one datagram message from one of a plurality of local endpoints communicatively coupled to said local NIC without establishing a dedicated connection, wherein at least a portion of said at least one datagram message is to be delivered to at least one of a plurality of remote endpoints communicatively coupled to said at least one remote NIC; and
communicating said at least a portion of said at least one datagram message via said local NIC to said at least one of a plurality of remote endpoints via said at least one communication channel without establishing a dedicated connection between said one of a plurality of local endpoints and said at least one of a plurality of remote endpoints.

2. The method according to claim 1, comprising receiving from said one of a plurality of local endpoints by said local NIC, said at least one datagram message comprising at least one of the following: a remote address, a local port, a remote port, and a payload.

3. The method according to claim 2, further comprising selecting said at least one communication channel based on said remote address.

4. The method according to claim 2, further comprising identifying said one of a plurality of local endpoints based on said local port.

5. The method according to claim 2, wherein said at least one of a plurality of remote endpoints is identified based on said remote port.

6. The method according to claim 1, further comprising receiving at least one acknowledgement in response to said communicated said at least a portion of said at least one datagram message, without subsequently communicating said at least one acknowledgement to said one of a plurality of local endpoints.

7. The method according to claim 1, wherein said establishing said at least one communications channel by said local NIC comprises:
communicating a connection request message from said local NIC to said remote NIC; and
receiving by said local NIC a corresponding connection response message from said remote NIC.

8. The method according to claim 7, wherein said connection request message comprises at least one of the following: a local address, and a corresponding local port.

9. The method according to claim 8, wherein said local address and said corresponding local port corresponds to one of said at least one communications channel.

10. The method according to claim 7, wherein said connection response message comprises at least one of the following: a remote address, and a corresponding remote port.

11. The method according to claim 10, wherein said remote address and said corresponding remote port corresponds to one of said plurality of remote endpoints.

12. The method according to claim 1, wherein said at least a portion of said datagram message is appended with a remote address and a corresponding remote port that corresponds to said remote NIC.

13. The method according to claim 1, wherein said at least one communications channel utilizes a transmission control protocol (TCP) connection.

14. The method according to claim 1, wherein said one of a plurality of local endpoints communicates via the user datagram protocol (UDP).

15. The method according to claim 1, wherein said one of a plurality of local endpoints communicates with said at least one of a plurality of remote endpoints via a cutthrough communications channel that bypasses said at least one communications channel.

16. The method according to claim 1, wherein said establishing, receiving, and communicating are performed by a processor within said local NIC.

17. A system for transporting information via a communications system, the system comprising:
a processor that establishes at least one communication channel between a local network interface card (NIC) and at least one remote NIC via at least one network;
said processor receives via said local NIC at least one datagram message from one of a plurality of local endpoints communicatively coupled to said local NIC without establishing a dedicated connection, wherein at least a portion of said at least one datagram message is to be delivered to at least one of a plurality of remote endpoints communicatively coupled to said at least one remote NIC; and
said processor communicates said at least a portion of said at least one datagram message via said local NIC to said at least one of a plurality of remote endpoints via said at least one communication channel without establishing a dedicated connection between said one of a plurality of local endpoints and said at least one of a plurality of remote endpoints.

18. The system according to claim 17, wherein said processor receives from said one of a plurality of local endpoints by said local NIC, said at least one datagram message comprising at least one of the following: a remote address, a local port, a remote port, and a payload.

19. The system according to claim 18, wherein said processor selects said at least one communication channel based on said remote address.

20. The system according to claim 18, wherein said processor identifies said one of a plurality of local endpoints based on said local port.

21. The system according to claim 18, wherein said at least one of a plurality of remote endpoints is identified based on said remote port.

22. The system according to claim 17, wherein said processor receives at least one acknowledgement in response to said communicated said at least a portion of said at least one datagram message, without subsequently communicating said at least one acknowledgement to said one of a plurality of local endpoints.

23. The system according to claim 17, wherein said establishing said at least one communications channel by said local NIC comprises:
communicating a connection request message from said local NIC to said remote NIC; and
receiving by said local NIC a corresponding connection response message from said remote NIC.

24. The system according to claim 23, wherein said connection request message comprises at least one of the following: a local address, and a corresponding local port.

25. The system according to claim 24, wherein said local address and said corresponding local port corresponds to one of said at least one communications channel.

26. The system according to claim 23, wherein said connection response message comprises at least one of the following: a remote address, and a corresponding remote port.

27. The system according to claim 26, wherein said remote address and said corresponding remote port corresponds to one of said plurality of remote endpoints.

28. The system according to claim 17, wherein said at least a portion of said datagram message is appended with a remote address and a corresponding remote port that corresponds to said remote NIC.

29. The system according to claim 17, wherein said at least one communications channel utilizes a transmission control protocol (TCP) connection.

30. The system according to claim 17, wherein said one of a plurality of local endpoints communicates via the user datagram protocol (UDP).

31. The system according to claim 17, wherein said one of a plurality of local endpoints communicates with said at least one of a plurality of remote endpoints via a cutthrough communications channel that bypasses said at least one communications channel.

32. The system according to claim 17, wherein the local NIC comprises the processor.
